(19) United States
(12) Patent Application Publication
(10) Pub. No.: US 2008/0244181 A1
(43) Pub. Date: Oct. 2, 2008

(54) Dynamic run-time cache size management

(76) Inventors: Michael Walz, Vancouver, WA (US); Venkat Ramana Yalla, Hillsboro, OR (US)

Correspondence Address: CAVEN & AGHEVLI;c/o INTELLEVATE, LLC, P.O. BOX 52050, MINNEAPOLIS, MN, 55402, US

(21) Appl. No.: 11/731,110

(22) Filed: Mar. 30, 2007

(51) Int. Cl. G06F 12/00

(52) U.S. Cl. 711/121

(57) ABSTRACT

Methods and apparatus relating to dynamic management of cache sizes during run-time are described. In one embodiment, the size of an active portion of a cache may be adjusted (e.g., increased or decreased) based on a cache busyness metric. Other embodiments are also disclosed.

### BACKGROUND

The present disclosure generally relates to the field of electronics. More particularly, an embodiment of the invention relates to dynamic management of cache sizes during run-time.

To improve performance, some processors may include a cache. Generally, a cache may store copies of data from most frequently used main memory locations. Since a cache has lower average access time than main memory, data stored in a cache may be fetched more quickly, resulting in improved performance. Therefore, increasing cache size may further enhance performance by improving the cache hit rate (or reducing potential cache misses). However, as the size of a cache is increased, the additional cache cells may consume more power. The additional power consumption may increase overall system average power which may, in turn, decrease the battery life of mobile computers. The additional power consumption may also increase heat generation which may, in turn, cause damage to the cache or other components of a computer that are thermally coupled to the cache. The additional heat may further limit the locations where a computer with a large cache may be used, for example, due to heat dissipation requirements.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4 illustrate block diagrams of embodiments of computing systems, which may be utilized to implement various embodiments discussed herein.

FIG. 2 illustrates a block diagram of portions of a cache and other components of a computing device, according to an embodiment of the invention.

FIG. 3 illustrates a block diagram of an embodiment of a method to manage the size of a cache.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

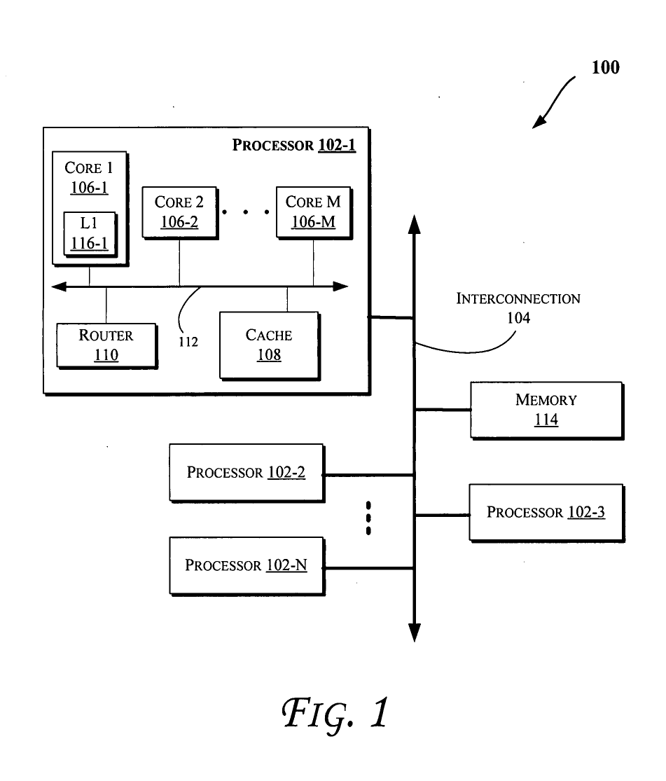

Some of the embodiments discussed herein may provide efficient mechanisms for managing the size of a cache, e.g., during run-time. In one embodiment, the size of a cache (such as the caches discussed with reference to FIGS. 1-4) may be adjusted by activating or deactivating a portion of the cache, including, for example, activating or deactivating one or more: cache bits, cache lines, cache ways, etc. Accordingly, the use of the term “portion of a cache” or “portion of the cache” (and their plural forms) herein is intended to mean any portion of a cache, including, for example, one or more: cache bits, cache lines, cache ways, etc. In an embodiment, dynamically managing the size of a cache may result in a more efficient power consumption scheme in computing systems that include one or more caches, such as those discussed with reference to FIGS. 1-4.

More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

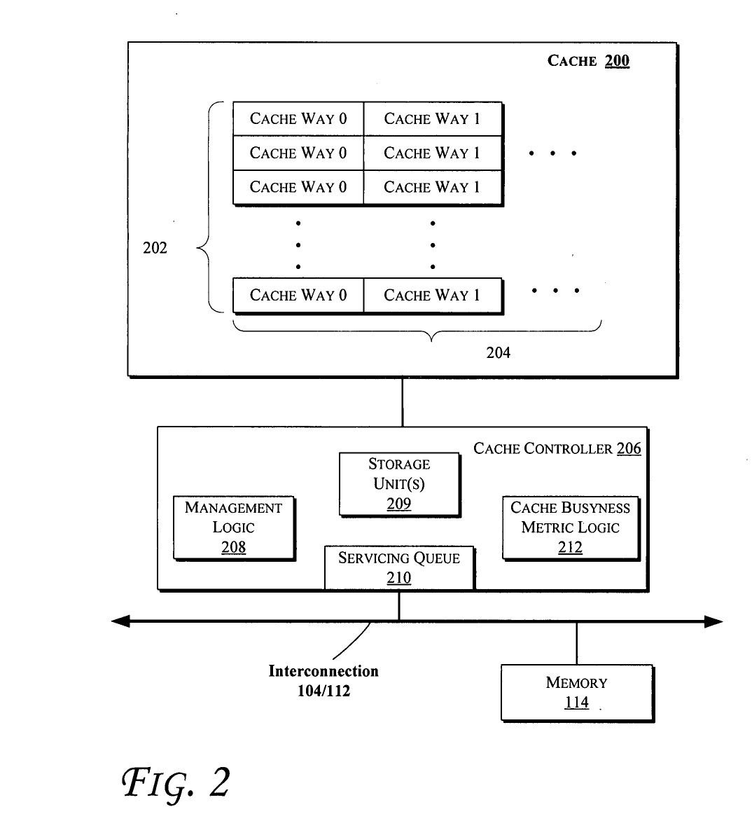

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 2-4), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

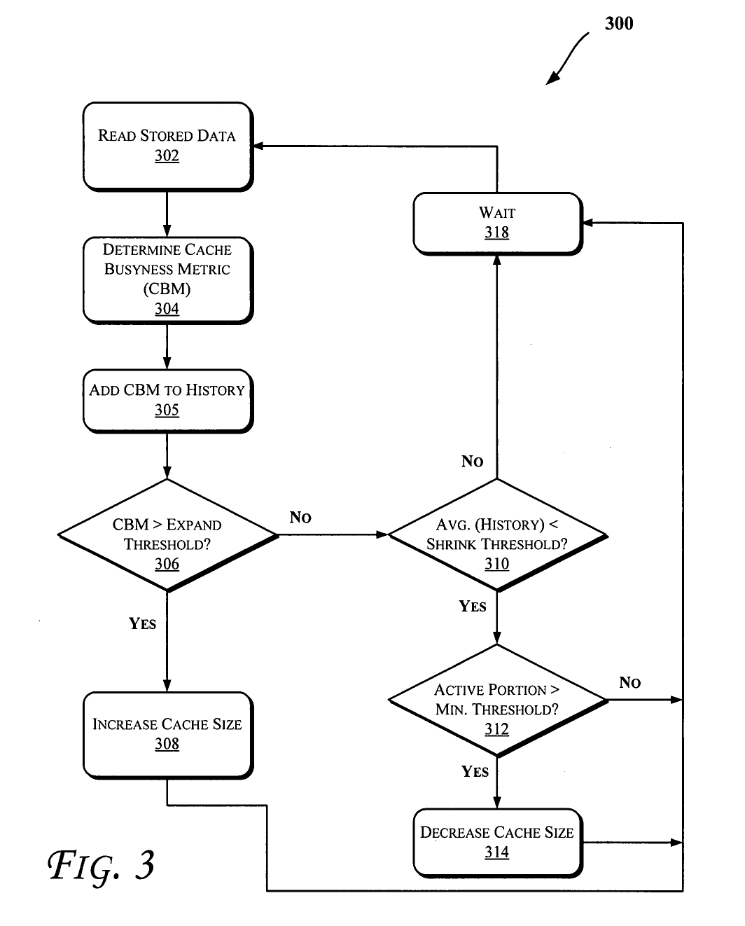

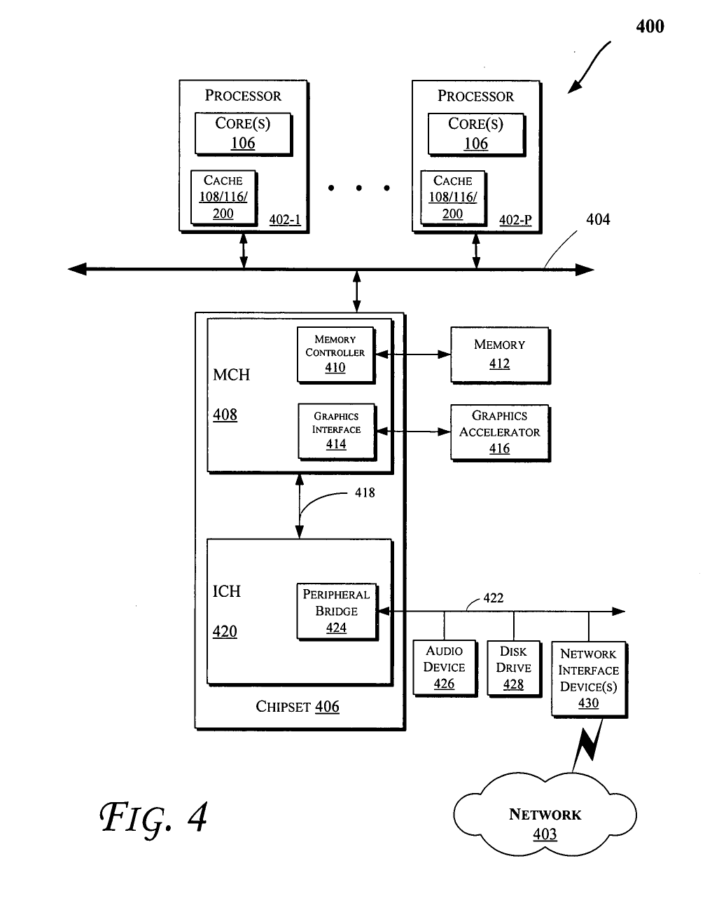

FIG. 2 illustrates a block diagram of portions of a cache 200 and other components of a computing device, according to an embodiment of the invention. In an embodiment, the cache 200 may be the same or similar to the caches discussed with reference to FIG. 1 (e.g., including caches 108 and/or 116). Also, embodiments discussed herein are not intended to be limited to caches. For example, similar techniques may be applied to any type of memory (such as the storage or memory devices discussed with reference to FIG. 4, for example). As shown in FIG. 2, the cache 200 may include one or more cache lines 202. The cache 200 may also include one or more cache ways 204 corresponding to each of the cache lines 202, as will be further discussed with reference to FIG. 3. In one embodiment, each location within the main memory 114 may be cached in any of locations 204 of a corresponding cache line 202. Having multiple cache ways may improve performance, e.g., by increasing cache hit rate, in accordance with some embodiments.

As illustrated in FIG. 2, the cache 200 may communicate via one or more of the interconnections 104 and/or 112 discussed with reference to FIG. 1 through a cache controller 206 with other components of a computing system. Also, embodiments discussed herein are not intended to be limited to cache controllers. For example, similar techniques may be applied to any type of memory controller (such as the memory controller discussed with reference to FIG. 4, for example).The cache controller 206 may include logic for various operations performed on the cache 200. For example, the cache controller 206 may include a management logic 208 (e.g., to manage which portion of the cache 200 is activated or deactivated), one or more storage units 209 (e.g., to store data corresponding to the utilization of the cache 200), a servicing queue 210 (e.g., to temporary store data communicated with the cache 200), and/or a cache busyness metric (CBM) logic 212 (e.g., to determine the value of a CBM based on data stored in the storage units 209). Alternatively, one or more of the logics 208, 209, 210, and/or 212 may be provided within other components of the processors 102 of FIG. 1. For example, the storage units 209 may be implemented within hardware registers or a location with the memory devices discussed herein (such as, for example, a location within the caches 108, 116, 200, and/or memory 114).

In an embodiment, the management logic 208 may be capable of flushing individual cache portions and/or disabling access to the cache portions. For example, a power transistor may be coupled to each portion of the cache 200 to control the supply of power to individual cache portions. In some embodiments, one or more of the storage units 209 may be designated as one or more configuration registers that are capable of accepting input that modifies the configuration details, e.g., such as: shrink and/or expand thresholds, shrink step size, history queue depth, sampling interval, etc., as will be further discussed herein, for example, with reference to FIG. 3. Also, in one embodiment, a software implementation may be used that is capable of monitoring utilization of the cache 200, e.g., by executing the policy and flushing or controlling individual active cache portions.

FIG. 3 illustrates a block diagram of an embodiment of a method 300 to manage the size (e.g., ways) of a cache. In an embodiment, various components discussed with reference to FIGS. 1-2 and 4 may be utilized to perform one or more of the operations discussed with reference to FIG. 3. For example, the method 300 may be used to manage the size and/or ways of caches 108 and 116 of FIG. 1 and/or cache 200 of FIG. 2.

Referring to FIGS. 1-3, at an operation 302, stored data that may correspond to the utilization of a cache may be read (e.g., data stored in one or more of the storage units 209 may be read by the CBM logic 212). At an operation 304, the value of CBM may be determined (e.g., by the CBM logic 212) based on the stored data of operation 302.

In an embodiment, at operation 304, the CBM may be determined based on the following:

CBM Value=[(Cycles_{Processor}_{_{—}}_{Executing}−Cycles_{Cache}_{_{—}}_{Inactive})/Number_of_Cycles]*100

In the above formula, Cycles_{Processor}_{_{—}}_{Executing} is the number of cycles a processor (or a processor core) coupled to the cache is executing instructions during period Time_1, Cycles_{Cache}_{_{—}}_{Inactive} is the number of cycles during which the queue servicing the cache requests (e.g., queue 210) is empty during period Time_1 (e.g., as determined by the management logic 208), and Number_of_Cycles is the number of cycles during period Time_1. Hence, the storage units 209 may store data that corresponds to the values discussed with respect to the above formula. For example, the management logic 208 may monitor various operations and update the corresponding values in the storage units 209, in accordance with some embodiments.

In an embodiment, the calculated CBM at operation 304 may be an indicator of cache utilization, e.g., based upon cache accesses over a select time period (as tracked by the management logic 208 that causes corresponding data to be stored in the units 209, for example). At an operation 305, the calculated CBM value of operation 304 may be stored in a history queue, e.g., displacing the oldest value. At operation 306, the CBM may be mapped against an expand threshold and if greater, the active portion of the cache may be expanded (e.g., fully) at an operation 308, e.g., by accessing the storage units 209 and having the management logic 208 cause an increase in the size of the active portion of the cache 200 (for example, by opening additional cache ways 204). An embodiment may partially expand or use multiple expand thresholds to determine the new target cache size at operations 308 and 306, respectively.

At operation 306, if the CBM does not exceed the expand threshold, values within a history queue (which may be stored in the storage units 209) may be averaged and the subsequent result may be compared to a shrink threshold at operation 310. If the result falls below the shrink threshold and the active portion of the cache is greater than a minimum cache size threshold value at operation 312, the size of the active portion of the cache may be decreased (e.g., a pre-configured portion of the cache may be flushed (for example, by logic 208 or other logic within the controller 206) and access may be disabled at operation 314 (such as discussed with reference to FIG. 2). An alternative embodiment may include multiple shrink thresholds to determine the new target cache size. Additional logic may be used to remove power from cache ways or sets of ways at operation 314, thus improving power management in some embodiments.

In an embodiment, the configuration values may be about: 11.11 for expand threshold of operation 306, 5.60 for shrink threshold of operation 310, 8 for the history queue depth of operation 310, 250 ms for the evaluation period (Time_1) discussed above, a step size of 2 for size increases or decreases of operation 308 and/or 314, etc. Step size may refer to the granularity of cache shrinking. For example, if the step size is 1, the cache may be shrunk one way (provided the cache is not already in its minimum size as determined at operation 312, for example). Likewise if the step size value is 2, the cache may be shrunk by 2 ways and so on. So if the cache has 8 ways and the step size is 1, the shrink sequence may be 8, 7, 6, 5, 4, 3, 2 and if step size is 2, the sequence is 8, 6, 4, 2.

Moreover, some of these values may be somewhat conservative. Changing these values may make the cache shrinking behavior more aggressive, but perhaps at the cost of performance. In an embodiment, the recommendation for the setting may be based on the power/performance objectives of a user. Further, configuration options at initialization time may include providing one or more the above values in accordance with an embodiment. Additionally, in one embodiment, run-time re-configuration may be performed based on external policy (AC/DC, user preference, etc.).

As shown in FIG. 3, after operations 308, 310, 312, and/or 314, an optional operation 318 may delay the control flow for a pre-configured period of time before re-sampling data at operation 302.

Accordingly, some embodiments of the invention relate to techniques for dynamically determining the correct cache size (e.g., cache ways) based upon cache utilization, thus allowing cache size (e.g., cache ways) to be shrunk and expanded to meet system demand. Given the direction of larger processor LLC sizes and more efficient power transistors, such embodiments may provide opportunities to run systems with less cache, thus allowing greater opportunities for power-savings techniques to be applied. In addition to possible (e.g., run-time) power management savings, some of the embodiments are capable of pre-shrinking caches to allow cooperative cache-shrinking technologies (such as deep C4 in accordance with at least one instruction set architecture) to invoke more often. An additional embodiment may involve the use of the calculated CBM data to augment the expand/shrink decisions of existing technologies (such as deep C4).

FIG. 4 illustrates a block diagram of a computing system 400 in accordance with an embodiment of the invention. The computing system 400 may include one or more central processing unit(s) (CPUs) or processors 402-1 through 402-P (which may be referred to herein as “processors 402” or “processor 402”). The processors 402 may communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. In some embodiments, one or more of the processors 402 may include one or more of the cores 106 of FIG. 1 and/or cache 200 of FIG. 2. Also, the operations discussed with reference to FIGS. 1-3 may be performed by one or more components of the system 400.

A chipset 406 may also communicate with the interconnection network 404. The chipset 406 may include a memory control hub (MCH) 408. The MCH 408 may include a memory controller 410 that communicates with a memory 412 (which may be the same or similar to the memory 114 of FIG. 1). The memory 412 may store data, including sequences of instructions that are executed by the processor 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a graphics accelerator 416. In one embodiment of the invention, the graphics interface 414 may communicate with the graphics accelerator 416 via an accelerated graphics port (AGP). In an embodiment of the invention, a display (such as a flat panel display, a cathode ray tube (CRT), a projection screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow the MCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the processor 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and one or more network interface device(s) 430 (which is in communication with the computer network 403). Other devices may communicate via the bus 422. Also, various components (such as the network interface device 430) may communicate with the MCH 408 in some embodiments of the invention. In addition, the processor 402 and the MCH 408 may be combined to form a single chip. Furthermore, the graphics accelerator 416 may be included within the MCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

For example, a computer-readable medium may comprise one or more instructions that when executed on a processor configure the processor to: determine a cache busyness metric of a cache based on stored data; and adjust a size of an active portion of the cache based on a value of the cache busyness metric. The one or more instructions may further configure the processor to add the value of the cache busyness metric to a history queue. Also, the one or more instructions may adjust the size of the active portion of the cache is performed in response to a comparison of an average of values stored in a history queue and a shrink threshold. In an embodiment, the one or more instructions may adjust the size of the active portion of the cache is performed in response to a comparison of: an average of values stored in a history queue and a shrink threshold; and the size of the active portion of the cache and a minimum cache size threshold value.

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
one or more storage units to store data corresponding to a cache;
a first logic to determine a cache busyness metric of the cache based on the stored data; and
a second logic to cause an adjustment to a size of an active portion of the cache based on a value of the cache busyness metric.

2. The apparatus of claim 1, wherein the first logic is to determine the cache busyness metric based on a length of time during which the cache is inactive.

3. The apparatus of claim 1, wherein the first logic is to determine the cache busyness metric based on a number of cycles during a first time period when the cache is inactive, a number of cycles that a processor coupled to the cache is executing instructions during the first time period, and a number of cycles during the first time period.

4. The apparatus of claim 1, wherein the active portion of the cache corresponds to one or more of: a number of active cache lines of the cache, one or more active bit cells of the cache, or a number of active cache ways of the cache.

5. The apparatus of claim 1, further comprising a cache controller that comprises one or more of the first logic or the second logic.

6. The apparatus of claim 1, wherein the one or more storage units comprise one or more of a hardware register or a counter.

7. The apparatus of claim 1, wherein the cache comprises a plurality of cache ways and the second logic is to cause an adjustment to a number of active cache ways of the plurality of cache ways based on the value of the cache busyness metric.

8. The apparatus of claim 1, further comprising a processor that comprises one or more of the storage units, the cache, the first logic, or the second logic.

9. The apparatus of claim 1, wherein one or more of the cache, at least one of the storage units, or one or more processor cores are on a same die.

10. The apparatus of claim 1, wherein the cache comprises one or more of a level 1 (L1) cache, a level 2 (L2) cache, a mid-level cache (MLC), or a last level cache (LLC).

11. The apparatus of claim 1, wherein the second logic is to cause the adjustment to the size of the active portion of the cache during run-time.

12. A method comprising:
determining a cache busyness metric of a cache based on stored data;
adjusting a size of an active portion of the cache based on a value of the cache busyness metric.

13. The method of claim 12, further comprising adding the value of the cache busyness metric to a history queue.

14. The method of claim 12, wherein adjusting the size of the active portion of the cache is performed in response to a comparison of an average of values stored in a history queue and a shrink threshold.

15. The method of claim 12, wherein the adjusting the size of the active portion of the cache is performed in response to a comparison of:
an average of values stored in a history queue and a shrink threshold; and
the size of the active portion of the cache and a minimum cache size threshold value.
